(19) United States
(12) Patent Application Publication
(10) Pub. No.: US 2019/0165996 A1
(43) Pub. Date: May 30, 2019

(54) Method for operating a real -time-capable simulation network having multiple network nodes for computing a simulation model, also computer program product relating thereto, and computer-readable storage medium

(71) Applicant: dSPACE digital signal processing and control engineering GmbH, Paderborn (DE)

(72) Inventors: Matthias KLEMM, Paderborn (DE); Heiko KALTE, Paderborn (DE); Robert POLNAU, Paderborn (DE); Thorsten BREHM, Paderborn (DE); Jochen SAUER, Brakel (DE); Hans-Juergen MIKS, Paderborn (DE); Robert LEINFELLNER, Paderborn (DE); Ruediger KRAFT, Paderborn (DE); Magnus ASPLUND, Braunschweig (DE); Matthias SCHMITZ, Paderborn (DE)

(73) Assignee: dSPACE digital signal processing and control engineering GmbH, Paderborn (DE)

(21) Appl. No.: 15/822,521

(22) Filed: Nov. 27, 2017

(51) Int. Cl. H04L 12/24; G06F 9/54; G06F 13/42; H04L 29/08; H04L 12/18

(52) U.S. Cl. CPC H04L 41/0681; G06F 9/542; G06F 13/4282; G06F 2213/0016; H04L 67/10; H04L 67/12; H04L 12/1895; H04L 41/145

(57) ABSTRACT

A method for operating a real-time-capable simulation network having multiple network nodes for computing a simulation model. The network nodes are connected to one another via a serial data bus, and the network nodes exchange data via data bus messages. At least one event-driven task of the simulation model is implemented on a first network node, and a nondeterministic triggering event is detected by a second network node. The second network node communicates the detected triggering event to the first network node and the first network node computes the event-driven task. A fast response time is achieved by the means that a detection signal is sent from the second network node in the form of a multicast data bus message or a broadcast data bus message to multiple network nodes of the simulation network or to all network nodes of the simulation network over the serial data bus.

### BACKGROUND OF THE INVENTION

### Field of the Invention

The invention relates to a method for operating a real-time-capable simulation network having multiple network nodes for computing a simulation model, wherein the network nodes are connected to one another by means of a serial data bus, and the network nodes exchange data by means of data bus messages, wherein at least one event-driven task of the simulation model is implemented on a first network node, wherein a nondeterministic triggering event is detected by a second network node, wherein the second network node communicates the detected triggering event to the first network node by transmission of a detection signal, and the first network node computes the event-driven task after receiving the detection signal.

Methods of the type described above for operating a real-time-capable simulation network have been in use for some years, in particular in control unit development for distributed systems. Fields of application typically reside in the area of very complex technical systems, as for example in automotive applications, in aerospace, and in other demanding industrial areas where extensive use is made of open-loop and closed-loop controls.

### Description of the Background Art

In the applications that are of interest here, multiple network nodes—it is not unusual for there to be several tens or more—are connected to one another through a serial data bus, or even several serial data buses, and jointly carry out a control task in the broadest sense of the term. The network nodes are typically connected to a physical technical process; they acquire information through sensors about states of the process and exert influence on the connected physical technical process through connected actuators.

The network nodes usually have varying designs, although they can also have identical characteristics; typically, the network nodes are set up for certain specialized tasks, however. Some network nodes essentially provide massive computing capacity in order to compute control algorithms and manage the processing of relatively large quantities of data, where this generally must be carried out subject to real-time requirements. The real-time requirement is a simple result of the fact that the networks considered here are, at least in part, in direct use with a real physical technical process. Microprocessors, microcontrollers, and even hard-wired functional components such as FPGAs (Field Programmable Gate Arrays) are used as computing units for network nodes of this type.

Other network nodes implement more of a measurement or actuation specialization in which the emphasis is not so much on a particular computing capacity, but rather on providing suitable I/O interfaces, for example in the form of analog interfaces with suitable analog-to-digital converters and digital-to-analog converters, PWM inputs and outputs, digital inputs and outputs, and if applicable interfaces for specific bus protocols. The dividing line between the different network nodes with different specializations is fluid; network nodes specialized for computing can also have I/O interfaces, just as network nodes specialized for sensing or actuation typically have suitable computing units.

Taken as a whole, the above-described networks constitute distributed discrete-time sampled-data systems.

In order to develop networks and network components of this type, individual network nodes or even large parts of the network having multiple network nodes are simulated in real time. In this context, a distinction is made largely between the application cases of Rapid Control Prototyping (RCP) and hardware-in-the-loop simulation (HIL simulation). In Rapid Control Prototyping, several—or even all—network nodes of the actual network are replaced by development hardware, which is generally more powerful than the production network nodes that will actually be used later. The network nodes are then typically programmable by means of a graphical programming environment and a connected automatic code generator, so that various functionalities can be implemented and can be tested in the actual physical environment within a very short time.

In hardware-in-the-loop simulation, exactly the opposite application case is tested, which is to say the production control units existing at the end of development, in the form of network nodes, are tested in a simulated hardware environment, wherein the simulated environment includes a part of the network with simulated network nodes and at least a part of the connected physical process. The method considered here for operating a real-time-capable simulation network applies equally to both application cases.

As already explained, the network with its network nodes constitutes a distributed discrete-time sampled-data system. Viewed from the standpoint of time, there are two types of tasks that must be processed by the various network nodes. There are the tasks that run, as it were, in time with the sampled-data system, and therefore run completely deterministically, and there are other tasks that are unforeseeable in time, and thus are processed nondeterministically, and cannot be planned into a time scheme. Tasks of the first type are often called “timer tasks” and are processed periodically. For example, there may be tasks that are executed every millisecond or even only every 50 milliseconds, or indeed with other period lengths that are an integer multiple of the smallest sampling period length. Examples of such timer tasks, which is to say “time-driven” tasks, are the periodic computation of deviations and controlled variables, as well as the acquisition of measurement data from the process and the output of controlled variables to the connected process.

Nondeterministic applications, which thus are nonperiodic and consequently cannot be predictably executed or computed, are also called “event-driven” tasks or nonperiodic tasks. The computation of such tasks is triggered by similarly nondeterministic events (influencing of the physical process by operators, alteration of boundary conditions, etc.). The present case is concerned with the handling of this type of nondeterministic events, which trigger the computation of an event-driven task associated therewith.

It is known to the applicant from practice that a nondeterministic triggering event is detected by the second network node, and the second network node first communicates the detected triggering event to the first network node, which has an event-driven task connected to this detected triggering event. The first network node in turn notifies all other network nodes from which it absolutely requires data for computing the event-driven task, whereupon these network nodes acquire these data (measurement, computation), and then transmit the acquired data back to the reporting first network node. Thus, the computation of the event-driven task on the first network node is then made possible. The result that only involved network nodes participate is achieved by the directly addressed back-and-forth transmission of detection signals, requests for information, and the information itself. On the other hand, this procedure is quite time-intensive. Other methods, in which separate physical signal lines are provided for transmission of triggering events or of the related detection signals, entail a considerable added effort (cabling, complicated connectors, etc.).

### SUMMARY OF THE INVENTION

The object of the present invention is to specify the method set forth above for operating a real-time-capable simulation network having multiple network nodes with which the above-described disadvantages are at least partially remedied.

The object derived above is initially and substantially attained according to the invention for the above-presented method by the means that the detection signal is sent from the second network node in the form of a multicast data bus message or a broadcast data bus message to multiple network nodes of the simulation network or to all network nodes of the simulation network over the serial data bus. The detection signal here—unlike in the prior art—is thus sent not only to the first network node with the event-driven task that is to be executed, but instead is sent simultaneously to multiple network nodes (multicast data bus message) or to all network nodes (broadcast data bus message).

When the detection signal is sent by means of a broadcast data bus message, all network nodes are notified practically simultaneously of the detection of the triggering event, creating the possibility that all network nodes participating in the computation of the event-driven task can also trigger the necessary measures practically simultaneously. When the detection signal is sent by means of a multicast data bus message, the data bus message is sent, for example, to all network nodes that relate to the event-driven task initiated by the nondeterministic triggering event. A function of the event-driven task can be the sending of signals over I/O interfaces, for example. The I/O interfaces here can be connected directly to one of the network nodes participating in the event-driven task. Optionally, context information can be sent in addition to the detection signal in the same message or in an additional broadcast or multicast message. Context information includes information that relates to the triggering event. Context information can be, e.g., the state of the second network node at the time of the detection of the triggering event or the current measurement value of an I/O interface of the second network node. Context information can be taken into account by network nodes when processing the event-driven task.

In a preferred embodiment of the method, provision is made that the network nodes that have a data item necessary for computing the event-driven task are equipped with a correspondence information item, wherein the correspondence information item includes the triggering event, the source of the data item, and—directly or indirectly—the first network node on which the event-driven task is computed. The correspondence information item makes it possible for the network nodes that have a data item necessary for computing the event-driven task to determine, with the aid of the received detection signal, which data item within their sphere of influence should be prepared and where the data item of interest should be sent.

In this case, the necessary data item can be sent directly to the first network node, where the event-driven task is in fact being computed. However, the data item can also be sent indirectly, which is to say by way of the detour through at least one other network node. In any case, the correspondence information item includes a description of the “path to the destination” that should be taken through network nodes of the simulation network until the necessary data item—in its original form or modified along the way—reaches its destination in the form of the first network node. In other words, the method is designed accordingly such that, upon receiving the multicast data bus message or the broadcast data bus message, the network nodes that have a data item necessary for computing the event-driven task prepare this necessary data item and send it with a data bus message directed to another network node. This other network node need not necessarily be the first network node; rather, the necessary data item may also take a detour through additional network nodes to the first network node.

An improvement of the described method is distinguished in that a local event of the second network node and/or an external event of the second network node is detected as a nondeterministic triggering event. A local event can be, e.g., an error or a state change that is taking place. The detection of an external event preferably occurs by means of an I/O interface of the second network node, and in this case it may be, for example, an event from the connected technical process that is detected through the I/O interface. The I/O interface can also be an—additional—communication interface, which is to say the event can also consist in the reception of a specific data bus message.

It has previously been stated that the network nodes that have a data item necessary for computing the event-driven task prepare this necessary data item. In one embodiment of the method, the preparation of the necessary data item comprises the readout of the aforementioned I/O interface of the second network node, or even of the I/O interface of another network node through which the first network node is indirectly informed. Alternatively or in addition, provision can be made that the preparation of the necessary data item comprises the determination of the necessary data item through a preprocessing of other data. Thus, for example, a multidimensional family of characteristic curves that places multiple quantities in relationship to one another can be stored in a network node, wherein all quantities except for one quantity are determined through, e.g., readout of measured values or even internal calculation variables, and the remaining quantity is determined from the family of characteristic curves.

A preferred embodiment of the method is distinguished in that the preparation of the necessary data item and/or the sending of the data bus message directed to a network node—in particular the first network node—takes place with higher priority than the computation of other processes or the sending of other data bus messages. In order to incur the lowest possible latencies, provision is made in particular for the preparation and/or the sending to take place with the highest priority. This ensures that possible delays in the response to the nondeterministic triggering event are minimized. Of course, for this purpose it is necessary for both the operating system on the network nodes and the protocol on which the exchange of data bus messages is based to permit a corresponding prioritization.

Furthermore, provision is made in a particular embodiment of the method that the correspondence information item includes an information item about the event-driven task, in particular wherein the data bus message directed to the first network node performing the computation also includes an information item on the basis of which the first network node can associate the data item with the event-driven task. Thus, in a certain sense the information item is an identifier for unique identification. This information item can be a memory address in which the data are stored in the first network node, for example. The applicable event-driven task can read the applicable current data from this address out of the local memory of the first network node and use it for the task computation.

Another embodiment of the method is characterized in that the correspondence information item is determined at least partially automatically from a simulation model and is stored in the network nodes before the start of computation of the simulation model. In addition or alternatively, the correspondence information item can also be dynamically changed at simulation run time.

In an especially preferred improvement of the method, the event-driven task on the first network node starts with the processing of another associated data item as early as following receipt of the multicast data bus message or the broadcast data bus message. This means, in particular, a data item that is already present on the first network node and is sufficiently up-to-date. All such additional associated data items that are already currently available can be incorporated into the computation of the event-driven task this early without resulting in inaccuracies. Moreover, this mode of procedure reduces the overall response time or processing time of the event-driven task. To ensure that only a current necessary data item that originates from a different network node than the first network node is used in every case, all such received necessary data items or the memory locations in which they are stored are marked with a flag that at first indicates that the data item has not yet been received in updated form since the calling of the event-driven task. Only after the necessary data item or necessary data items have been sent by network nodes different from the first network node is each corresponding flag switched such that it indicates valid data. Each time, before the event-driven task on the first network node reads memory locations corresponding to necessary data items sent from outside, it checks whether the data are in fact current—which is to say valid. After computation of the event-driven task is complete, the corresponding flags are switched again so that the memory contents stored there are marked as invalid—which is to say not current.

An especially preferred embodiment of the method makes provision that the time is determined that a necessary data item requires to reach the first network node from the second network node after receipt of the multicast data bus message or the broadcast data bus message, that furthermore the time is calculated that the first network node requires after receipt of the multicast data bus message or the broadcast data bus message to start computation of the event-driven task and reach the execution point in the event-driven task that accesses the necessary data item, and that the computation of the event-driven task is started on the first network node, taking the ascertained times into account, such that the event-driven task can access a necessary data item without additional waiting for a necessary data item. As a result of this mode of procedure, it is ensured through the use of advance knowledge of certain execution times that the computation of the event-driven task automatically uses only current and externally obtained data items. In any case, this could make a validation system for ensuring the freshness of received data unnecessary.

Another variant for ensuring a current data basis in the calculation of the event-driven task consists in that the first network node determines whether all data necessary for computing an event-driven task have arrived, and computation of the event-driven task on the first network node does not start until all necessary data have arrived. Although this method does not realize the shortest response time, the method can be implemented with very simple means.

Another measure for reducing latencies consists in that the multicast data bus message or the broadcast data bus message is sent and/or forwarded with a higher priority than all other data bus messages. For this purpose the serial data bus used must also have appropriate instruments for prioritizing messages.

The invention additionally includes a computer program product comprising instructions that, when the programs are executed by multiple network nodes of a real-time capable simulation network for computing a simulation model, cause the network nodes to carry out the steps of the above-described method. In addition, the invention likewise includes a computer-readable storage medium on which the above-described computer program product is stored.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 a method known from the prior art for operating a real-time-capable simulation network having multiple network nodes,

FIG. 2 a method for operating a real-time-capable simulation network having multiple network nodes using a broadcast data bus message to communicate a detection signal,

FIG. 3 a method for operating a real-time-capable simulation network using multicast data bus messages to communicate a detection signal,

FIG. 4 the configuration of a network node with correspondence information for directly addressing a first network node,

FIG. 5 the configuration of another network node with correspondence information with indirect routing of a data item to the first network node through the detour of another network node,

FIG. 6 a timing diagram to clarify the matching of transmission and computing times, and

FIG. 7 another timing diagram to clarify the matching of transmission and computing times.

### DETAILED DESCRIPTION

Methods 1 for operating a real-time-capable simulation network 2 having multiple network nodes 3, 3.1, 3.2, 3.3, 3.4 for computing a simulation model 4, 4.1, 4.2 are shown in each of the various figures. Shown in each case are simulation networks 2 with multiple network nodes 3, wherein process sequences from the diagrams logically result from the signal flow and the sequences of data communication that are shown and described.

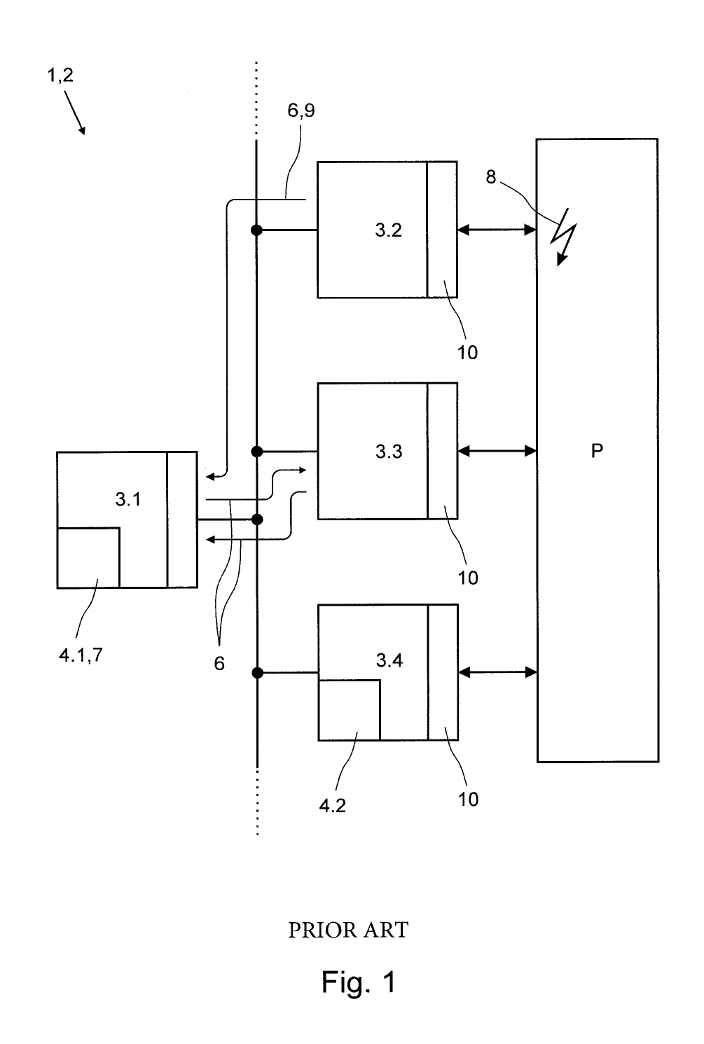

FIG. 1 shows, first of all, a method 1 known from the prior art for operating a real-time-capable simulation network 2. Shown in total are four network nodes 3.1, 3.2, 3.3, 3.4, which are connected to one another through a serial data bus 5. The network nodes 3 exchange data bus messages 6 that are based on a specific communication protocol over the serial data bus 5. As is indicated in the figures, the serial data bus 5 extends even further, and thus many more network nodes may also be included. In the present case, the network nodes 3 that are shown are development network nodes, which in other words do not correspond to the production network nodes that will actually be used later. The network nodes 3 of the simulation network 2 interact with an indicated physical process P. In the present case, the network nodes 3.2, 3.3, 3.4 can exchange data, indicated by the double-headed arrows, with the physical process P, which may be an internal combustion engine, an electric motor, or a different system, for example. The network nodes 3.2, 3.3, 3.4 can acquire, in particular, measurement data from the process P and they can also influence the process P through the output of appropriate signals.

Shown here is that the simulation model 4 is distributed over two network nodes 3.1, 3.4, namely in the form of the parts 4.1, 4.2 of the simulation model 4. An event-driven task 7 is implemented on the network node 4.1 [sic; should be 3.1] within the framework of the part 4.1 of the simulation model 4 on the network node 3.1.

A nondeterministic triggering event 8 is detected by the second network node 3.2, with this second network node 3.2 communicating the detected triggering event 8 to the first network node 3.1 by transmission of a detection signal 9. This detection signal 9 is thus transmitted by means of a data bus message 6. It is known to the first network node 3.1 that it must compute the event-driven task 7 that is connected with the triggering event 8 after receiving the detection signal 9. However, in order to compute the event-driven task 7, the first network node 3.1 needs additional information that is not stored on the first network node 3.1 itself but instead must first be obtained from other network nodes 3, in this case from the additional network node 3.3. To this end, the first network node 3.1 requests a necessary information item from the additional network node 3.3 (directed arrow with a data bus message 6 from the first network node 3.1 to the additional network node 3.3). In response to this request for information, the additional network node 3.3 then supplies the required information in the form of another data bus message 6 (directed arrow from the additional network node 3.3 to the first network node 3.1). As a result of the above-described procedure, only the network nodes 3 that are absolutely required in order to compute the event-driven task 7 are addressed, but a relatively long response time to the triggering event 8 must be accepted.

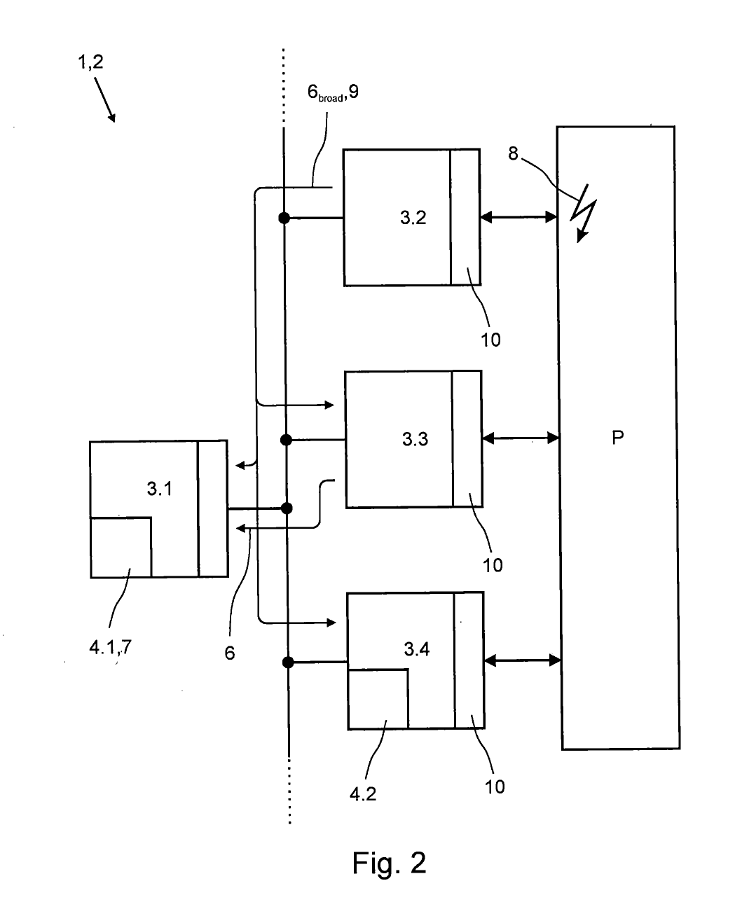

In the method illustrated in FIG. 2, the object of computing the event-driven task 7 on the first network node 3.1, triggered by the detected triggering event 8 by means of the second network node 3.2, is attained in another manner. Here too, the triggering event 8 is detected by means of the second network node 3.2, and here too, the first network node 3.1 is informed by the second network node 3.2 through transmission of the detection signal 9 that the triggering event 8 has been detected. In contrast to FIG. 1, however, the detection signal 9 is sent from the second network node 3.2 to all network nodes 3, 3.1, 3.2, 3.3, 3.4 of the simulation network 2 over the serial data bus 5 in the form of a broadcast data bus message 6_{broad}. This has the advantage that it is now possible for all network nodes 3 to respond instantaneously to the detected triggering event 8. As a result of this measure, it is easily possible for the additional network node 3.3 to check whether it must prepare an information item that may be necessary for computing the event-driven task 7 associated with the detected event 8. This information item can then be determined and transmitted to the first network node 3.1 by means of a data bus message 6 (directed arrow from the additional network node 3.3 to the first network node 3.1) with practically no delay, within the scope of technical possibility. In addition, the network nodes 3.3, 3.4 that receive the broadcast data bus message 6_{broad} and that have an I/O interface 10 can measure or transmit data in response to the broadcast data bus message 6_{broad}. Thus, a network node 3.3 can measure additional data of the physical process P and send it to the first network node 3.1 as a data bus message. Or one or more network nodes 3.3, 3.4 can send data to the physical process P through their I/O interfaces 10.

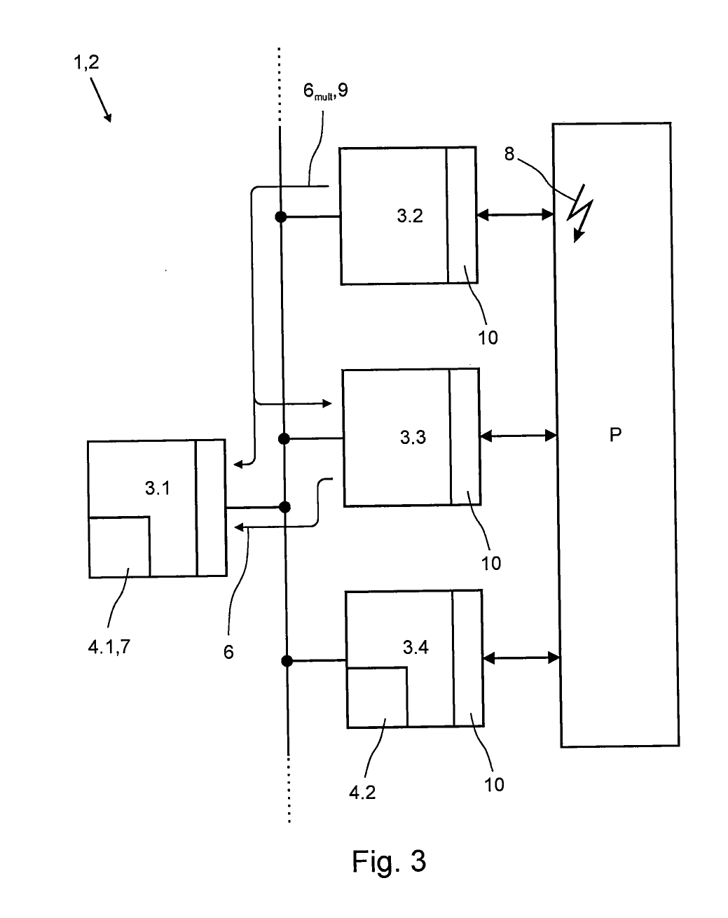

It is shown in FIG. 3 that the detection signal is sent from the second network node 3.2 to multiple network nodes 3.1, 3.3 of the simulation network 2 over the serial data bus 5 in the form of a multicast data bus message 6ₘᵤₗₜ, wherein the triggering event 8 or the associated detection signal is sent only to precisely those network nodes 3.1, 3.3 that affect the computation of the event-driven task 7 on the first network node 3.1. In this case, a checking of the message by the network nodes (in this case network node 3.4) that have not been addressed at all by the multicast data bus message 6ₘᵤₗₜ is superfluous. In this example too, a network node 3.3 can interact with the physical process P through its I/O interface 10 in response to the multicast data bus message 6ₘᵤₗₜ.

In the examples shown, an external event of the second network node 3.2 is detected as a nondeterministic triggering event 8, namely in the present case a nondeterministic event in the physical process P is detected with an I/O interface 10 of the second network node 3.2.

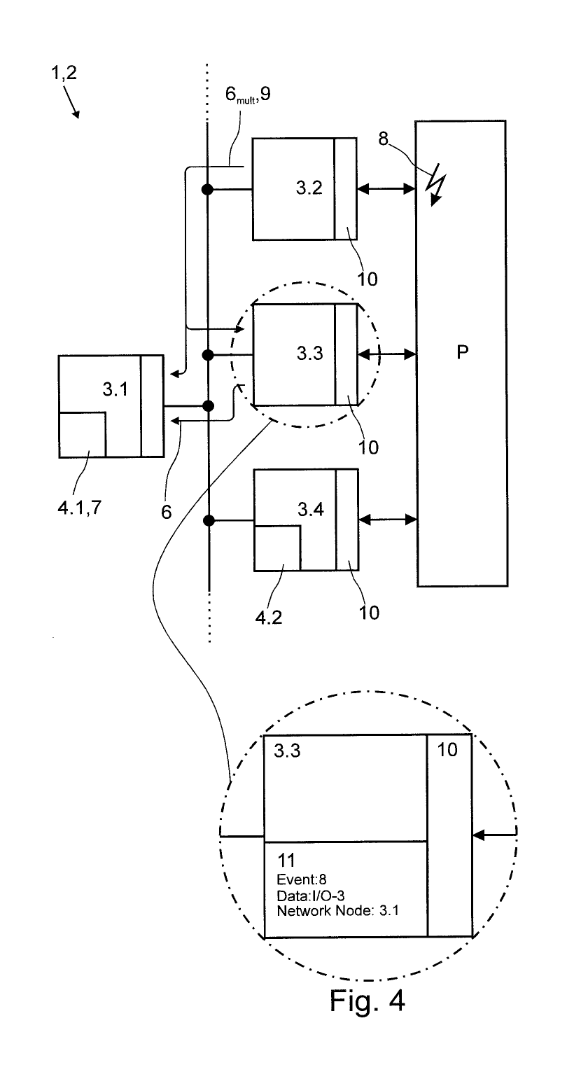

It is shown in FIG. 4 that the network node 3.3, which has a data item necessary for computing the event-driven task 7, is equipped with a correspondence information item 11, wherein the correspondence information item 11 includes the triggering event 8 (event: 8), the source of the data (data item: I/O-3), and, directly or indirectly, the first network node (network node: 3.1) on which the event-driven task 7 is computed. “I/O-3” is specified as the source of the data item, which is intended here to indicate that the third channel of the I/O interface 10 of the network node 3.3 is to be read out and the data item thus obtained is then to be used further.

The behavior in the exemplary embodiments from FIG. 2 onward is basically similar, as the network nodes 3.3, which have a data item necessary for computing the event-driven task 7, prepare this necessary data item upon receiving the multicast data bus 6ₘᵤₗₜ or the broadcast data bus message 6_{broad} and send it with a data bus message 6 directed to another network node 3, wherein the final destination is the first network node 3.1 since it computes the event-driven task 7.

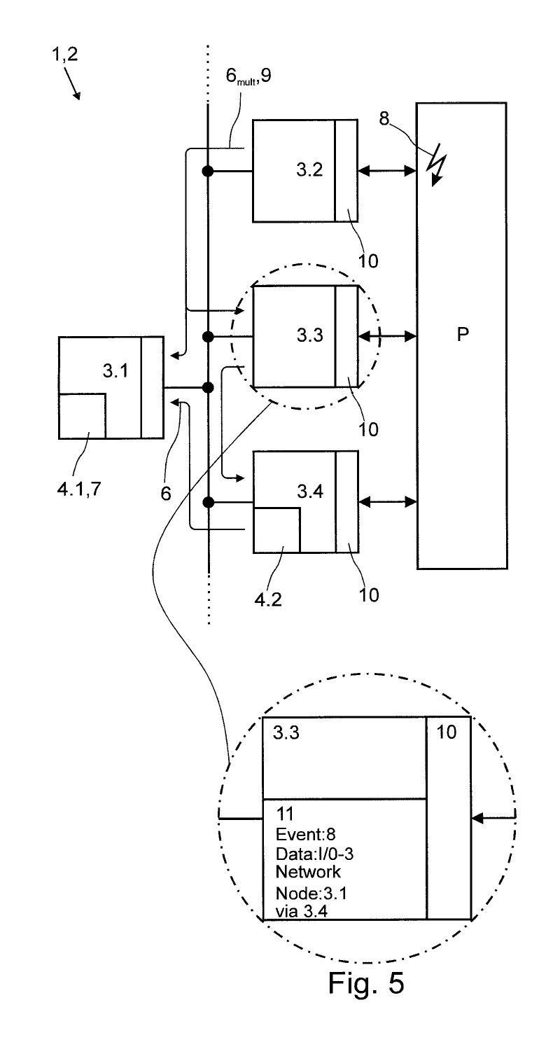

The sending of the necessary data item need not always take place directly with a data bus message 6 that is directed immediately to the first network node 3.1. Shown in FIG. 5 is an example of indirect transmission of the necessary data item from the additional network node 3.3. Here, the data item prepared by the additional network node 3.3 is first sent to the additional network node 3.4 with a data bus message 6. In this respect, the correspondence information item 11 also contains further information on how to reach the final destination in the form of the first network node 3.1, namely via the network node 3.4 (network node: 3.1 via 3.4). The additional network node 3.3 thus transmits the data item it has acquired to the additional network node 3.4. In the present case the transmitted data item is used for a computation within the framework of the partial simulation model 4.2, and a result obtained there is then directed to the first network node 3.1. In this exemplary embodiment, the preparation of the necessary data item thus comprises the readout of the I/O interface 10 of the additional network node 3.3 as well as the determination, through a preprocessing of additional data on the additional network node 3.4 as part of the computation of the partial simulation model 4.2, of the necessary data item that is ultimately transmitted.

In the embodiments shown, the preparation of the necessary data item takes place with the highest priority, which is to say that the additional network node 3.3 immediately stops processing other tasks upon receipt of the detection signal 9 and, in the present case, reads out the third channel of its I/O interface 10. Provision is likewise made in the exemplary embodiments that the sending of the data bus messages 6 directed to the additional network nodes 3.1, 3.3, 3.4, and in particular to the first network node 3.1, takes place with higher priority than the sending of other data bus messages 6, so that a short response time is guaranteed in this way.

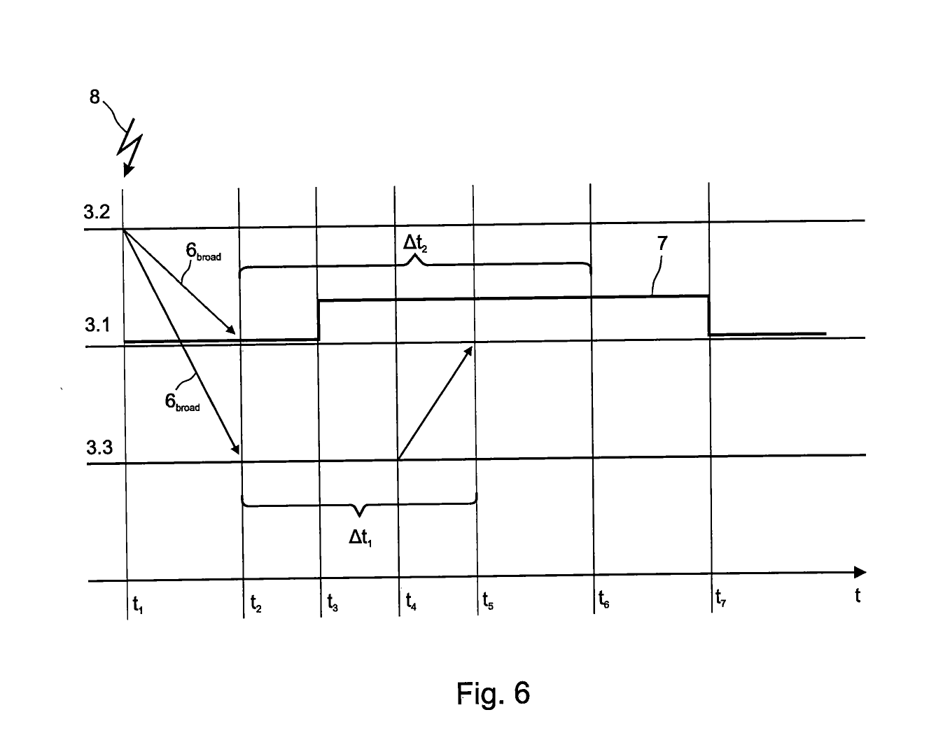

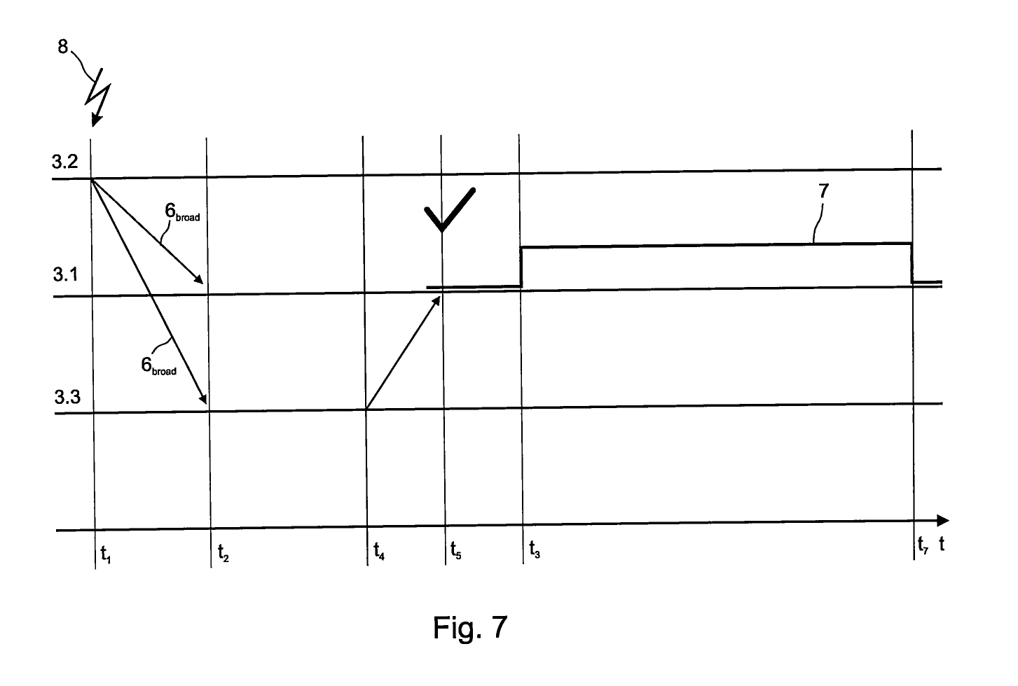

It is shown schematically in FIGS. 6 and 7 with the aid of timing diagrams how transmission and computing times can be favorably matched to one another. In the diagram in FIG. 6, the situation is presented that the event-driven task 7 on the first network node 3.1 starts immediately after receipt of the broadcast data bus message 6_{broad} at the time t₂ with the processing of an additional associated data item, which is not shown in detail here. The additional associated data item is stored locally on the network node 3.1 and is also available to this extent. It is readily evident that the event-driven task 7 cannot be started immediately after receipt of the broadcast data bus message 6_{broad} at the time t₂, but instead that it only starts with a certain delay, namely at time t₃. It is assumed in the illustration that the data item necessary for computing the event-driven task 7 is not needed immediately, which is to say not immediately at the start of the event-driven task 7, but instead is only needed at a later time, labeled time t₆ in FIG. 6. Now, provision is made in an advantageous embodiment that the time Δt₁, which a necessary data item requires to reach the first network node 3.1 from the additional network node 3.3 after receipt at the time t₂ of the broadcast data bus message 6_{broad}, is determined. Furthermore, the time Δtₜ is determined that the first network node 3.1 requires after receipt of the broadcast data bus message 6_{broad} to start the computation of the event-driven task 7 (rising edge on the axis 3.1 of the network node 3.1) and reach the execution point t₆ in the event-driven task 7 at which the prepared necessary data item is first accessed. The computation of the event-driven task 7 on the first network node 3.1 can then be started, taking the determined times Δt₁, Δt₂ into account such that the event-driven task 7 can access a necessary data item without additional waiting. In the exemplary embodiment shown, the process is noncritical, since the necessary data item is already available on the first network node 3.1 at the time t₅ and the part of the computation of the event-driven task 7 that needs this data item, which is to say starting at the time t₆, follows the reception time t₅. If the time Δt₁ were longer than the time Δtₜ, the event-driven task 7 could be initiated later by exactly this time difference after receipt of the broadcast data bus message 6_{broad} at the first network node 3.1.

In the method from FIG. 7, such a calculation of a time offset is not necessary, since provision is made here that the first network node 3.1 determines whether all data necessary for computing the event-driven task 7 have arrived, and does not start the computation of the event-driven task 7 until then. Here, the first network node 3.1 thus establishes at time t₅ that it has received the necessary data item from the additional network node 3.3 and at this time initiates the computation of the event-driven task 7, which starts with a time offset relative to the later time t₃. The method is less resource-intensive than the method described in FIG. 6, while being simpler in its implementation. However, it must be taken into account that longer response times are to be expected. The end point t₇ of the computation of the event-driven task 7 for the method from FIG. 7 lags considerably behind the corresponding time t₇ in FIG. 6

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for operating a real-time-capable simulation network having multiple network nodes for computing a simulation model, the method comprising:
connecting the network nodes to one another by means of a serial data bus, and the network nodes exchange data by means of data bus messages;
implementing at least one event-driven task of the simulation model on a first network node, wherein a nondeterministic triggering event is detected by a second network node, wherein the second network node communicates the detected triggering event to the first network node by transmission of a detection signal; and
computing, via the first network node, the event-driven task after receiving the detection signal, characterized in that
wherein the detection signal is sent from the second network node in the form of a multicast data bus message or a broadcast data bus message to multiple network nodes of the simulation network or to all network nodes of the simulation network over the serial data bus.

2. The method according to claim 1, wherein a local event of the second network node and/or an external event of the second network node is detected as a nondeterministic triggering event, in particular wherein the external event of the second network node is detected with an I/O interface of the second network node.

3. The method according to claim 1, wherein the network nodes that have a data item necessary for computing the event-driven task are equipped with a correspondence information item, wherein the correspondence information item includes the triggering event, the source of the data item, and, directly or indirectly, the first network node on which the event-driven task is computed.

4. The method according to claim 1, wherein, upon receiving the multicast data bus message or the broadcast data bus message, the network nodes that have a data item necessary for computing the event-driven task prepare this necessary data item and send it with a data bus message directed to another network node, in particular with a data bus message directed to the first network node, wherein the first network node computes the event-driven task.

5. The method according to claim 2, wherein, the preparation of the necessary data item comprises the readout of the I/O interface.

6. The method according to claim 4 wherein, the preparation of the necessary data item comprises the determination of the necessary data item through a preprocessing of other data.

7. The method according to claim 5 wherein, the preparation of the necessary data item and/or the sending of the data bus message directed to the other network nodes, in particular the first network node, takes place with higher priority than the computation of other processes or the sending of other data bus messages, in particular wherein the preparation and/or the sending takes place with the highest priority.

8. The method according to claim 3 wherein, the correspondence information item includes an information item about the event-driven task, in particular wherein the data bus message directed to the first network node performing the computation also includes an information item on the basis of which the first network node can associate the data item with the event-driven task.

9. The method according to claim 4, wherein, the correspondence information item is determined at least partially automatically from a simulation model and is stored in the network nodes before the start of computation of the simulation model, and/or the correspondence information item is dynamically changed at simulation run time.

10. The method according to claim 1 wherein, the event-driven task on the first network node starts with the processing of another associated data item as early as following the receipt of the multicast data bus message or the broadcast data bus message.

11. The method according to claim 1, wherein, the time is determined that a necessary data item requires to reach the first network node from the second network node after receipt of the multicast data bus message or the broadcast data bus message, that furthermore the time is determined that the first network node requires after receipt of the multicast data bus message or the broadcast data bus message to start computation of the event-driven task and reach the execution point in the event-driven task that accesses the necessary data item, and that the computation of the event-driven task is started on first network node, taking the ascertained times into account, such that the event-driven task can access a necessary data item without additional waiting for the necessary data item.

12. The method according to claim 1 wherein the first network node determines whether all data necessary for computing an event-driven task have arrived, and does not start the computation of the event-driven task until then.

13. The method according to claim 1, wherein, the multicast data bus message or the broadcast data bus message is sent and/or forwarded with a higher priority than other data bus messages

14. A computer program product, comprising instructions that, when the programs are executed by multiple network nodes of a real-time capable simulation network for computing a simulation model, cause the network nodes to carry out the steps of the method according to claim 1.

15. The computer-readable storage medium, on which the computer program product according to claim 14 is stored.
